(19) United States
(12) Patent Application Publication
(10) Pub. No.: US 2008/0213157 A1
(43) Pub. Date: Sep. 4, 2008

(54) PROCEDURES FOR AMMONIA PRODUCTION

(75) Inventors: Gerard Sean McGrady, Lincoln (CA); Christopher Willson, Fredericton (CA)

Correspondence Address: Hiscock & Barclay, LLP, One Park Place, 300 South State Street, Syracuse, NY, 13202-2078, US

(73) Assignee: HSM Systems, Inc., Fredericton (CA)

(21) Appl. No.: 12/015,277

(22) Filed: Jan. 16, 2008

Related U.S. Application Data
(60) Provisional application No. 60/880,613, filed on Jan. 16, 2007.
(60) Provisional application No. 60/943,443, filed on Jun. 12, 2007.

(51) Int. Cl. C01C 1/04

(52) U.S. Cl. 423/353; 423/362

(57) ABSTRACT

Systems and methods for producing ammonia. In one approach, Li₃N is reacted with hydrogen to produce ammonia and is regenerated using nitrogen. Catalysts comprising selected transition metals or their nitrides can be used to promote the reactions. In another approach, supercritical anhydrous ammonia is used as a reaction medium to assist the reaction of hydrogen with nitrogen to produce ammonia, again promoted using catalysts.

### CROSS-REFERENCE TO RELATED APPLICATIONS

This application claims priority to and the benefit of co-pending U.S. provisional patent application Ser. No. 60/880,613, filed Jan. 16, 2007, and claims priority to and the benefit of co-pending U.S. provisional patent application Ser. No. 60/943,443, filed Jun. 12, 2007, each of which applications is incorporated herein by reference in its entirety.

### FIELD OF THE INVENTION

The invention relates to methods and apparatus for producing ammonia in general and particularly to methods and apparatus that permit the production of ammonia at lower temperatures and/or lower pressures than are conventionally used.

### BACKGROUND OF THE INVENTION

Ammonia is a very useful chemical, both in its own right and as a chemical intermediate. Anhydrous ammonia finds uses in refrigeration, for example in ice making and frozen food production. Ammonia can be used in water treatment, by being converted to chloramine, a disinfectant that destroys trihalomethanes, which are known carcinogens. Ammonia can be used in heat treatment of metals, for example in processes such as nitriding and annealing. Ammonia can be used as a material useful in controlling NOₓ emissions. Ammonia is also useful in chemical processing, for example, as a reagent, and for pH control.

The Haber Process (also known as Haber-Bosch process and Fritz Haber Process) is the reaction of nitrogen and hydrogen to produce ammonia. The nitrogen (N₂) and hydrogen (H₂) gases are reacted, usually over an iron or ruthenium catalyst, for example one containing trivalent iron (Fe³⁺). The reaction is carried out according to Eq. 1 under conditions of 250 atmospheres (atm) pressure, at a temperature commonly in the range of 450-500° C., resulting in a equilibrium yield of 10-20% ammonia:

N₂(g)+3H₂(g)⇄2NH₃(g)ΔH=−92.4 kJ mol⁻¹ Eq. 1

The reaction of Eq. 1 is reversible, meaning the reaction can proceed in either the forward (left to right) or the reverse direction depending on conditions. The forward reaction is exothermic, meaning it produces heat and is favored at low temperatures, according to Le Chatelier's Principle. Increasing the temperature tends to drive the reaction in the reverse direction, which is undesirable if the goal is to produce ammonia. However, lowering the temperature reduces the rate of the reaction, which is also undesirable. Therefore, an intermediate temperature high enough to allow the reaction to proceed at a reasonable rate, yet not so high as to drive the reaction in the reverse direction, is required. Usually, temperatures around 450° C. are used.

High pressures favor the forward reaction because there are 4 moles of reactant for every 2 moles of product, meaning the position of the equilibrium will shift to the right to produce more ammonia, because reduction in the number of moles of gas in the reaction vessel will tend to reduce the pressure, all else being held constant. However, the higher the pressure, the more robust and expensive the reaction vessel and associated apparatus must be. Therefore, the pressure is increased as much as possible consonant with the cost of equipment. Usually, pressures of the order of 200-250 atm are used.

The catalyst has no effect on the position of equilibrium. Rather it alters the reaction pathway, by reducing the activation energy of the reaction system and hence in turn increasing the reaction rate. The use of a catalyst allows the process to be operated at lower temperatures, which as mentioned before favors the forward reaction. However, the advantage that would be gained by finding an improved catalyst or process that operated at lower temperatures is borne out by considering the temperature dependence of the equilibrium constant for the synthesis reaction of NH₃ from N₂ and H₂, detailed in Table I below.

TABLE 1

| T/° C. | 25 | 200 | 300 | 400 | 500 |
|---|---|---|---|---|---|
| K_{eq} | 6.4 × 10² | 4.4 × 10¹ | 4.3 × 10⁻³ | 1.6 × 10⁻⁴ | 1.5 × 10⁻⁵ |

The equilibrium constant is a well known ratio in chemistry. A larger equilibrium constant favors the production of more chemical product and the consumption of chemical reagents (e.g., the reaction has a greater tendency to proceed to the right). The ammonia is formed as a gas but on cooling in the condenser liquefies at the high pressures used, and so is removed as a liquid. Unreacted nitrogen and hydrogen are then fed back in to the reaction. Removal of the product tends to cause the reactant-rich system that remains as described in Eq. 1 to move from left to right so as to approach thermodynamic equilibrium.

A number of problems in the conventional production of ammonia using the Haber process have been observed, including the large expenses that must be incurred for equipment that can operate safely under very high pressures and high temperatures, and also the operating costs of heating materials and apparatus to such high temperatures. It would be advantageous from an economic standpoint to eliminate some of these expenses.

There is a need for systems and methods for production of ammonia that avoid the high temperatures and high pressures that are required to carry out convention production methods, and that allow operation at lower costs than heretofore.

### SUMMARY OF THE INVENTION

In one aspect, the invention relates to a method of making ammonia. The method comprises the steps of providing a chemical reactor having a heater and associated heater control operatively connected thereto and configured to maintain the chemical reactor at a desired operating temperature; providing within the chemical reactor a quantity of a Li-bearing substance, a quantity of a catalyst configured to be accessible to the Li-bearing substance, a quantity of hydrogen-bearing gas and a quantity of nitrogen gas; operating the chemical reactor at a desired temperature to produce ammonia; and removing and purifying the ammonia so produced.

In one embodiment, the Li-bearing substance is lithium metal. In one embodiment, the Li-bearing substance is Li₃N. In one embodiment, the catalyst configured to be accessible to the Li-bearing substance comprises a transition metal. In one embodiment, the transition metal is a metal selected from the group consisting of iron, titanium, vanadium and manganese. In one embodiment, the transition metal is ruthenium. In one embodiment) the step of providing within the chemical reactor a quantity of a Li-bearing substance, a quantity of a catalyst configured to be accessible to the Li-bearing substance, a quantity of hydrogen-bearing gas and a quantity of nitrogen gas involves having all the enumerated reagents and catalysts present at one time. In one embodiment, the step of providing within the chemical reactor a quantity of a Li-bearing substance, a quantity of a catalyst configured to be accessible to the Li-bearing substance, a quantity of hydrogen-bearing gas and a quantity of nitrogen gas involves having less than all of the enumerated reagents and catalysts present at one time.

In another aspect, the invention features a method of making ammonia. The method comprises the steps of: providing a chemical reactor having a heater and associated heater control operatively connected thereto and configured to maintain the chemical reactor at a desired operating temperature, and having a pressure control operatively connected thereto and configured to maintain the chemical reactor at a desired operating pressure; providing within the chemical reactor a quantity of anhydrous ammonia; a quantity of a catalyst configured to be accessible to the anhydrous ammonia, a quantity of hydrogen-bearing gas and a quantity of nitrogen gas; operating the chemical reactor at a desired temperature and a desired pressure to cause the anhydrous ammonia to exist in a supercritical state; producing additional ammonia from the hydrogen-bearing gas and the nitrogen gas; and removing the additional ammonia so produced from the chemical reactor.

In one embodiment, the catalyst configured to be accessible to the anhydrous ammonia comprises a transition metal. In one embodiment, the transition metal is a metal selected from the group consisting of iron, titanium, vanadium and manganese. In one embodiment, the transition metal is ruthenium. In one embodiment, the step of providing within the chemical reactor a quantity of anhydrous ammonia; a quantity of a catalyst configured to be accessible to the anhydrous ammonia, a quantity of hydrogen-bearing gas and a quantity of nitrogen gas involves having all the enumerated reagents and catalysts present in the chemical reactor at one time. In one embodiment, the step of providing within the chemical reactor a quantity of anhydrous ammonia; a quantity of a catalyst configured to be accessible to the anhydrous ammonia, a quantity of hydrogen-bearing gas and a quantity of nitrogen gas involves having less than all of the enumerated reagents and catalysts present in the chemical reactor together at one time.

In still another aspect, the invention features a method of making ammonia. The method comprises the steps of: providing a chemical reactor having a heater and associated heater control operatively connected thereto and configured to maintain the chemical reactor at a desired operating temperature; providing within the chemical reactor a quantity of a catalyst comprising a metal nitride, a quantity of hydrogen-bearing gas and a quantity of nitrogen gas; operating the chemical reactor at a desired temperature to produce ammonia; and removing and purifying the ammonia so produced.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a diagram that illustrates the pressure-temperature relations of three phases, gas, liquid, and solid for the material CO₂, including the critical point of pressure and temperature above which the liquid and gaseous states merge into a supercritical state.

FIG. 2 is a schematic diagram illustrating the features of a chemical reactor in which aspects of the invention can be practiced.

### DETAILED DESCRIPTION OF THE INVENTION

### First Embodiment

In one aspect, this invention relates to the use of metal nitrides to catalyze the preparation of ammonia from hydrogen and nitrogen. There is currently a wide range of interest in lithium nitride, Li₃N, as a hydrogen storage material. This is because lithium nitride reacts reversibly with hydrogen at 250° C., according to Eq. 2.

Li₃N(s)+2H₂(g)⇄2LiH(s)+LiNH₂(s) Eq. 2

The adsorbed hydrogen can be released by heating, but it desorbs along with a small amount of ammonia, which tends to poison catalysts in fuel cells.

The iron catalyst described above assists in breaking the H—H bond, allowing dissociated hydrogen to react with the much more inert N₂ molecule. This is why relatively high temperatures are still needed for the production of ammonia. While high total pressures are a thermodynamic requirement of the process, a catalyst that is able to activate both N₂ and H₂ should allow the reaction to occur at significantly lower temperatures, with significant economic benefits in terms of improved yield of ammonia and lower process temperatures.

Lithium metal reacts directly with nitrogen and accordingly must be handled under argon. Lithium is one of the few metals that forms a stable nitride containing N³⁻. It is expected that the properties of mixed systems containing lithium and a range of transition metals, such as iron, titanium, vanadium and manganese can provide one or more catalysts that activate both N₂ and H₂. It is expected that the metal ruthenium can also be a useful catalyst. It is expected that a system comprising a metal catalyst or a metal nitride catalyst that does not include lithium may also be effective. In some embodiments, the transition metal can be present as a nitride, or it can be present in a composition that contains both lithium and the transition metal, including nitrides of either or both. Such systems are expected to provide a ternary nitride will have the potential to be an active catalyst in the Haber process, reacting directly with both N₂ and H₂, and activating both components of the ammonia synthesis gas mixture. The chemical nature of the adsorbed hydride can be tuned from acidic, through neutral, to basic, by appropriate choice of transition metal, and its proximity in the structure to the amide anion (NH₂⁻) should ensure facile reaction to produce ammonia in the presence of hydrogen or metal hydrides. The production of ammonia will leave a vacant nitride site in the structure (i.e. the nitrogen converted to ammonia will be expected to leave the structure), which can be filled by adsorption of or reaction with N₂. It is expected that the N³⁻ thus formed will react immediately with H₂ to regenerate another amide ion, thereby completing the cycle.

It is expected that such mixed metal systems can provide catalysts for the production of ammonia at temperatures and pressures that are more moderate than those used in the present conventional Haber process, thereby providing ammonia via a less expensive process.

In the embodiment described, substances are allowed to react in a chemical reactor that includes a heater and a heater control, so that a desired temperature can be maintained within the chemical reactor at the time that a particular chemical reaction is being carried out. In the embodiment described, there can be a method of making ammonia in which a quantity of a Li-bearing substance, a quantity of a catalyst configured to be accessible to the Li-bearing substance, a quantity of hydrogen-bearing gas and a quantity of nitrogen gas are all present at one time. Alternatively, there may be an embodiment in which less than all of the enumerated reagents and catalysts are present at one time, e.g., the reaction of lithium with nitrogen to form Li₃N is performed in the absence of hydrogen gas, and only later is hydrogen admitted to the reaction chamber or vessel.

### Second Embodiment

In another aspect, this invention relates to the use of a supercritical fluid, and in particular supercritical ammonia, as a reaction medium for the preparation of ammonia from hydrogen and nitrogen. Over the past decade, supercritical fluids have developed from laboratory curiosities to occupy an important role in synthetic chemistry and industry. Supercritical fluids combine the most desirable properties of a liquid with those of a gas: these properties include the ability to dissolve solids and total miscibility of the supercritical fluid with permanent gases. For example, supercritical carbon dioxide has found a wide range of applications in homogeneous and heterogeneous catalysis, including such processes as hydrogenation, hydroformylation, olefin metathesis and Fischer-Tropsch synthesis. Supercritical water has also found wide utility in enhancing organic reactions.

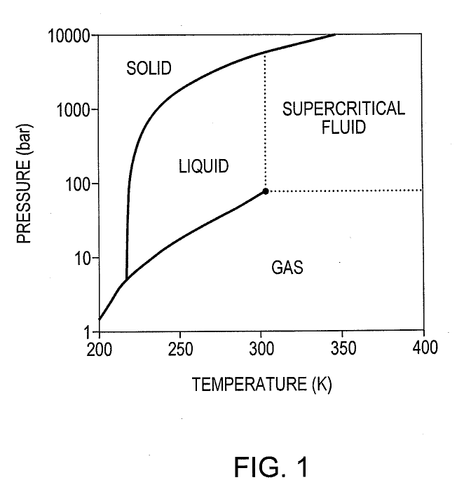

Supercritical fluids (SCFs) exist above the critical pressure and critical temperature of a material, as depicted in FIG. 1, the phase diagram for CO₂. In this regime the material enters a new phase, and the properties normally associated with gases and liquids are co-mingled. Thus the fluid can act as a solvent, at the same time remaining completely miscible with permanent gases like hydrogen. The mass- and thermal-transfer properties of a supercritical fluid offer significant advantages over conventional solid-gas or solid-solution approaches as outlined above, and these advantages have been recognized for over a decade. In fact, organic hydrogenation reactions have been carried out using supercritical fluids for several years, with some striking successes.

The total miscibility of permanent gases like H₂ and N₂ with a supercritical fluid means that very high concentrations of these gases can be attained in the medium. Furthermore, the low surface tension of the supercritical fluid allows for effective penetration of high surface area or porous solids; for example the iron catalysts described hereinabove. In addition, the high mass- and thermal-transfer characteristics of supercritical fluid are also advantageous in facilitating heterogeneous reactions or catalysis.

A preferred supercritical fluid medium for the preparation of NH₃ from H₂ and N₂ is ammonia itself. This has a critical temperature (T_{c}) of 132° C. and a critical pressure (p_{c}) of 113 bar. At temperatures and pressures above these values, NH₃ is in its supercritical phase. Supercritical fluids are generally quite convective when maintained at the requisite temperatures and pressures. Accordingly, it is expected that a catalyst comprising a solid portion of a transition metal or other catalytic substance can be made accessible to a mixture of a supercritical fluid and one or more gases dissolved therein even if the catalyst is placed to one side of the chemical reactor, for example in a side chamber that can be connected to or disconnected from the main portion of the chemical reactor by valved tubes. In this manner, a chemical reactor having a supercritical fluid with one or more reagent gases dissolved therein can be selectively exposed to the solid catalyst by the simple expedient of opening valves to allow the supercritical fluid to circulate past the solid catalyst, and can be selectively separated from the solid catalyst by the simple expedient of closing the valves, thereby shutting off the communication between the main portion of the chemical reactor and the side chamber. This may be useful for operating the chemical reactor to generate product, such as additional ammonia, at certain times, and at other time, preventing further reaction from taking place and opening the chemical reactor to remove some or all of the ammonia product.

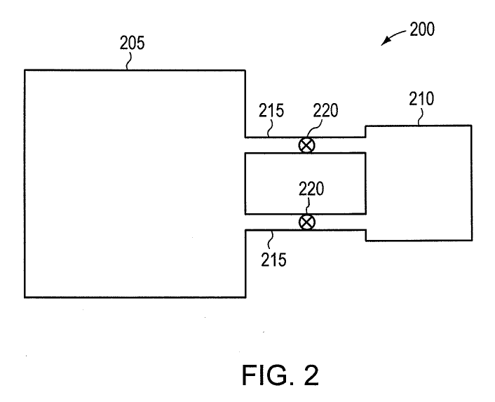

FIG. 2 is a schematic diagram illustrating the features of such a chemical reactor 200, including a main portion of the chemical reactor 205, a side chamber 210 that can contain a catalyst, tubes 215 that connect the main portion of the chemical reactor 205 and the side chamber 210, and valves 220 that allow communication via the tubes 215 when open and that shut off communication via the tubes 215 when closed. Well-known elements such as heaters, heating controllers, temperature measuring elements such as thermocouples and pyrometers, pressure valves, pressure controls and pressure measuring elements such as sensors or gauges can be added to the chemical reactors that are used in performing the chemical reactions described, and are not shown in FIG. 2 for simplicity.

It is anticipated that the advantageous properties of supercritical fluid media described above will permit high concentrations of H₂ and N₂ to be brought into intimate contact with an appropriate catalyst and reacted together effectively to form NH₃ at temperatures and total pressures significantly below those described for the Haber process, with significant savings in energy costs and improvements in overall yields. Use of the reaction product (NH₃) as the reaction medium also offers significant process costs in terms of subsequent separation, although many other materials may be considered as an appropriate supercritical fluid medium for carrying out the reaction described in Eq. 1. Some of the salient properties of potential media for the synthesis of NH₃ from N₂ and Hz are described in Table II below, but this is not an exhaustive list.

The catalysts that are expected to be useful in the production of ammonia using supercritical ammonia as a working fluid and using gaseous H₂ and N₂ as feed include a range of transition metals, such as iron, titanium, vanadium and manganese can provide one or more catalysts that activate both N₂ and H₂. It is expected that the metal ruthenium can also be a useful catalyst.

TABLE II

| | | T_{c} | p_{c} |
|---|---|---|---|
| Compound | Formula | (° C.) | (bar) |
| Ammonia | NH₃ | 132 | 113 |
| Carbon dioxide | CO₂ | 31 | 74 |
| Ethane | C₂H₆ | 32 | 49 |
| Propane | C₃H₈ | 97 | 42 |
| Sulfur hexafluoride | SF₆ | 46 | 58 |

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. A method of making ammonia, comprising the steps of:
providing a chemical reactor having a heater and associated heater control operatively connected thereto and configured to maintain said chemical reactor at a desired operating temperature;
providing within said chemical reactor a quantity of a Li-bearing substance, a quantity of a catalyst configured to be accessible to said Li-bearing substance, a quantity of hydrogen-bearing gas and a quantity of nitrogen gas;
operating said chemical reactor at a desired temperature to produce ammonia; and
removing and purifying said ammonia so produced.

2. The method of making ammonia of claim 1, wherein said Li-bearing substance is lithium metal.

3. The method of making ammonia of claim 1, wherein said Li-bearing substance is Li₃N.

4. The method of making ammonia of claim 1, wherein said catalyst configured to be accessible to said Li-bearing substance comprises a transition metal.

5. The method of making ammonia of claim 4, wherein said transition metal is a metal selected from the group consisting of iron, titanium, vanadium and manganese.

6. The method of making ammonia of claim 4, wherein said transition metal is ruthenium.

7. The method of making ammonia of claim 1, wherein the step of providing within said chemical reactor a quantity of a Li-bearing substance, a quantity of a catalyst configured to be accessible to said Li-bearing substance, a quantity of hydrogen-bearing gas and a quantity of nitrogen gas involves having all the enumerated reagents and catalysts present at one time.

8. The method of making ammonia of claim 1, wherein the step of providing within said chemical reactor a quantity of a Li-bearing substance, a quantity of a catalyst configured to be accessible to said Li-bearing substance, a quantity of hydrogen-bearing gas and a quantity of nitrogen gas involves having less than all of the enumerated reagents and catalysts present at one time.

9. A method of making ammonia, comprising the steps of:
providing a chemical reactor having a heater and associated heater control operatively connected thereto and configured to maintain said chemical reactor at a desired operating temperature, and having a pressure control operatively connected thereto and configured to maintain said chemical reactor at a desired operating pressure;
providing within said chemical reactor a quantity of anhydrous ammonia, a quantity of a catalyst configured to be accessible to said anhydrous ammonia, a quantity of hydrogen-bearing gas and a quantity of nitrogen gas;
operating said chemical reactor at a desired temperature and a desired pressure to cause said anhydrous ammonia to exist in a supercritical state;
producing additional ammonia from said hydrogen-bearing gas and said nitrogen gas; and
removing said additional ammonia so produced from said chemical reactor.

10. The method of making ammonia of claim 9, wherein said catalyst configured to be accessible to said anhydrous ammonia comprises a transition metal.

11. The method of making ammonia of claim 10, wherein said transition metal is a metal selected from the group consisting of iron, titanium, vanadium and manganese.

12. The method of making ammonia of claim 10, wherein said transition metal is ruthenium.

13. The method of making ammonia of claim 9, wherein the step of providing within said chemical reactor a quantity of anhydrous ammonia, a quantity of a catalyst configured to be accessible to said anhydrous ammonia, a quantity of hydrogen-bearing gas and a quantity of nitrogen gas involves having all the enumerated reagents and catalysts present in said chemical reactor at one time.

14. The method of making ammonia of claim 9, wherein the step of providing within said chemical reactor a quantity of anhydrous ammonia, a quantity of a catalyst configured to be accessible to said anhydrous ammonia, a quantity of hydrogen-bearing gas and a quantity of nitrogen gas involves having less than all of the enumerated reagents and catalysts present in said chemical reactor together at one time.

15. A method of making ammonia, comprising the steps of:
providing a chemical reactor having a heater and associated heater control operatively connected thereto and configured to maintain said chemical reactor at a desired operating temperature;
providing within said chemical reactor a quantity of a catalyst comprising a metal nitride, a quantity of hydrogen-bearing gas and a quantity of nitrogen gas;
operating said chemical reactor at a desired temperature to produce ammonia; and
removing and purifying said ammonia so produced.
